(19) United States
(12) Patent Application Publication
(10) Pub. No.: US 2015/0244522 A1
(43) Pub. Date: Aug. 27, 2015

(54) METHOD AND SYSTEM FOR PROVIDING DATA SECURITY

(71) Applicant: SAMSUNG ELECTRONICS CO., LTD., Suwon-si (KR)

(72) Inventors: Muhammad Saheer CHERUVATH, Bangalore (IN); Perumal Raj SIVARAJAN, Bangalore (IN)

(21) Appl. No.: 14/631,127

(22) Filed: Feb. 25, 2015

(30) Foreign Application Priority Data
Feb. 26, 2014 (IN) 971/CHE/2014

(51) Int. Cl. H04L 9/08; G06F 21/31

(52) U.S. Cl. CPC H04L 9/0894; G06F 21/31

(57) ABSTRACT

Embodiments herein provide a method for data security. A data passcode used for data encryption in electronic devices is encrypted and secret shares of the encrypted passcode are distributed to multiple entities. Recovery of the passcode and the encrypted data is performed by obtaining the secret shares from the multiple entities to reconstruct the passcode used for data encryption.

### PRIORITY

This application claims priority under 35 U.S.C. §119(a) to Indian Provisional Patent Application Serial No. 971/CHE/2014, which was filed in the Indian Intellectual Property Office on Feb. 26, 2014, and Indian Complete Patent Application Serial No. 971/CHE/2014, which was filed in the Indian Intellectual Property Office on Oct. 27, 2014, the entire contents of which are incorporated herein by reference.

### BACKGROUND

1. Field of the Invention

The present invention relates to data security and more particularly to a method and system of secure recovery of passcode associated with encrypted data.

2. Description of the Related Art

With increasing use of electronic devices for personal and enterprise activities, data present in the electronic devices may need higher security. To improve security of the data present in an electronic device, the electronic device manufacturers have introduced solutions, which provide a personal mode for personal data and a secure mode for sensitive data present in the electronic device. A secure environment may be provided for accessing the sensitive data and secure applications associated with the sensitive data. Examples of sensitive data may include enterprise data, data in applications requiring authentication like banking, ticketing, loyalty programs and the like.

For security of the secure mode and the sensitive data, a user of the electronic device may access the secure applications operating in the secure mode and the sensitive data through a passcode. The user passcode may be used for generating an encryption key for the secure data stored in the electronic device. If the user of the electronic device forgets the password, then the secure data in the electronic device may be lost as it may not be possible to recover the encryption key used to encrypt the secure data without password. In case, the user of the electronic device store sensitive data encrypted with the user's passcode in cloud storage, it may be difficult to recover the sensitive data in case of loss of the electronic device or a hardware failure.

Hence, there is a need to securely recover the password associated with the encrypted data to recover sensitive data from the electronic device

The above information is presented as background information only to help the reader to understand the present invention. Applicants have made no determination and make no assertion as to whether any of the above might be applicable as Prior Art with regard to the present application.

### SUMMARY

The principal object of the invention is to provide a method and system for data security in an electronic device.

Another object of the invention is to provide a method and system for passcode recovery in the electronic device.

Yet another object of the invention is to create multiple encrypted shares of a passcode or passcode hash and distribute the created multiple shares to a plurality of physically separated entities in a device management system.

Accordingly the embodiments herein provide a method of providing data security. The method includes generating a plurality of secret shares for an encrypted passcode and distributing each the secret share to a plurality of entities which are separated physically

Accordingly the embodiments herein provide a system for data security. The system is configured to generate a plurality of secret shares for an encrypted passcode and distribute each secret share to a plurality of entities which are separated physically.

A computer program product comprising computer executable program code recorded on a computer readable a non-transitory storage medium. The computer executable program code when executed causes the product to generate a plurality of secret shares for an encrypted passcode and distribute each secret share to a plurality of entities which are separated physically.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a block diagram of a Mobile Device Management (MDM) system, according to the embodiment as described herein;

FIG. 2 illustrates an overview of a system used for data security in electronic device, according to the embodiment as described herein;

FIG. 3 illustrates modules of the MDM server used for data security management, according to the embodiments as described herein;

FIG. 4 is a flow diagram illustrating a method of providing data security, according to the embodiments as described herein;

FIG. 5 is an example sequence diagram showing various operations performed by different entities for providing data security in the electronic device, according to the embodiments as described herein;

FIG. 6 is a flow diagram illustrating a method of recovering a passcode for recovery of encrypted data, according to the embodiments as described herein;

FIG. 7 is an example sequence diagram showing various operations performed by different entities recovering a passcode for data recovery from the electronic device, according to the embodiments as described herein;

FIG. 8 is an example illustration depicting the steps involved for recovering the passcode using a user interface, according to the embodiments as described herein;

FIG. 9 is an example illustration depicting the steps involved for recovering the passcode using a secret share sent to user and a secret share sent to the MDM server when the electronic device is lost, according to the embodiments as described herein; and

FIG. 10 depicts a computing environment implementing the method of providing data security, in accordance with various embodiments as described herein.

### DETAILED DESCRIPTION OF THE PRESENT INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Throughout the description the terms “mobile device” and “electronic device” have been used interchangeably and refer to electronic device including a data encrypted with a passcode.

Embodiments achieve a method and system of providing data security by encrypting the data. The data is encrypted with a user entered passcode. The passcode or a hash of the passcode is encrypted and divided into multiple secret shares and each of the multiple secret shares is distributed to a plurality of physically separated entities.

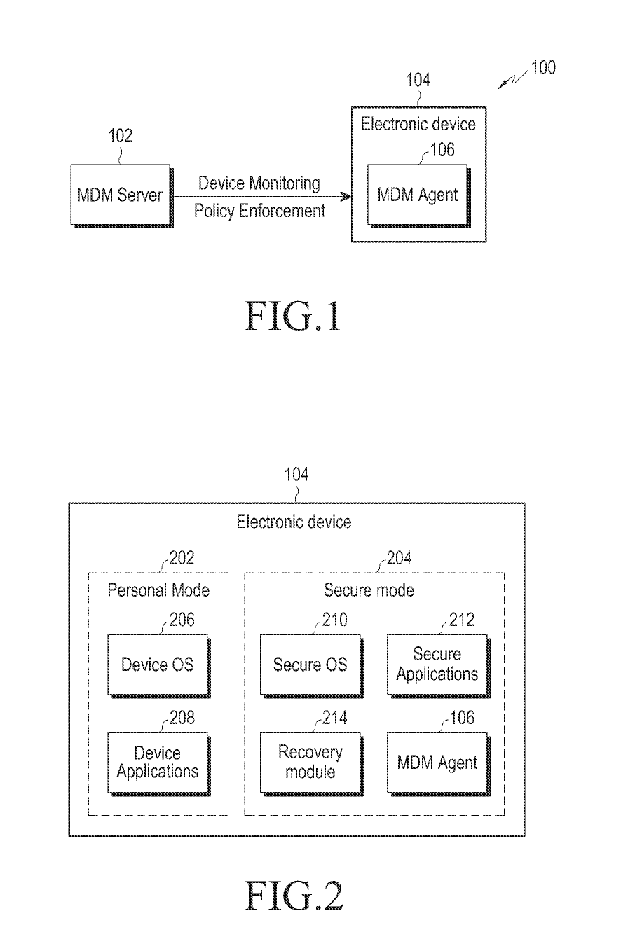

FIG. 1 illustrates a block diagram of an enterprise Mobile Device Management (MDM) system 100, according to the embodiment as described herein. The FIG. 1 shows a MDM server 102 used by an enterprise administrator to monitor enterprise data present in the electronic device 104. As BYOD (Bring Your Own Device) is becoming popular, companies may allow employees to use their smart phones or other mobile devices for official purpose. An enterprise data security is essential when the user's electronic device 104 is used for both personal activities and enterprise activities. The enterprise applications may run inside the secure environment in the electronic device 104 (as shown in FIG. 1). The enterprise data may be encrypted using the passcode. For accessing the encrypted data, the user needs to enter the passcode. The loss of the passcode may lead to loss of the enterprise data. The passcode may not be available with an enterprise administrator. In case the device is lost, or an employee has left the organization without providing the passcode of the electronic device 104, the encrypted data present in electronic device 104 or in cloud storage becomes inaccessible and may not be recovered. To prevent encrypted data loss and provide passcode recovery, the MDM server 102 can be configured to push a set of passcode recovery related policies to the electronic device 104 using secure channels like MDM, policy update and Over the Air (OTA) programming An MDM server 106 on the electronic device 104 allows communication between the MDM server 102 and the secure environment where the enterprise applications and encrypted data are running. In an embodiment, the MDM server 102 can be configured to enforce policies related to storage encryption, cloud access, external storage access, passcode strength, and passcode recovery.

Although the FIG. 1 is described for enterprise data security on mobile devices, it must be understood that the embodiments of the present invention may be applicable on any electronic device including both enterprise and non-enterprise data.

FIG. 2 illustrates an overview of a system used for data security in the electronic device, according to the embodiments as described herein. To provide security to sensitive data present in an electronic device 104, manufacturers have introduced a solution, which partitions memory and processing resources between a personal mode 202 or a non-secure mode, and a secure mode 204 (shown in FIG. 1). In an embodiment, the electronic device 104 described herein can be, but are not limited, a cell phone, a personal digital assistant, a mobile personal computer, a laptop, a tablet, a phablet, a desktop computer, a communicator, a server, an external storage, a cloud storage or equivalent thereof In the personal mode 202, a device operating system 206 can be configured to run the various device applications 208 present in the electronic device 104. The secure mode 204 uses a secure operating system 210 for secure applications 212. The applications running inside the secure mode 204 are immune against attacks from the personal mode 202 and any hardware attacks on the chip. Therefore, a secure execution environment is established and used for applications which require security like digital wallets, electronic ID's, Digital Rights Management (DRM) and the like. The non-critical part of the secure applications 212 such as the user interface can run in the personal mode 202 using the device 206 operating system while the critical code, private encryption keys and sensitive I/O operations such as “PIN code entry by user” can be handled by the secure mode 204.

In an embodiment, the secure mode 204 is implemented as a container in the electronic device 104. The container provides a secure environment in the electronic device 104 with its own home screen, launcher, applications and widgets. In the container type secure mode 204 implementations, each container can be associated with the passcode. Data present in the container is encrypted using an encrypted key. The encrypted key is generated using a user entered passcode.

The passcode or hash of the passcode is encrypted. A secure application 112 can be configured to create secret shares of the encrypted hash passcode or the passcode.

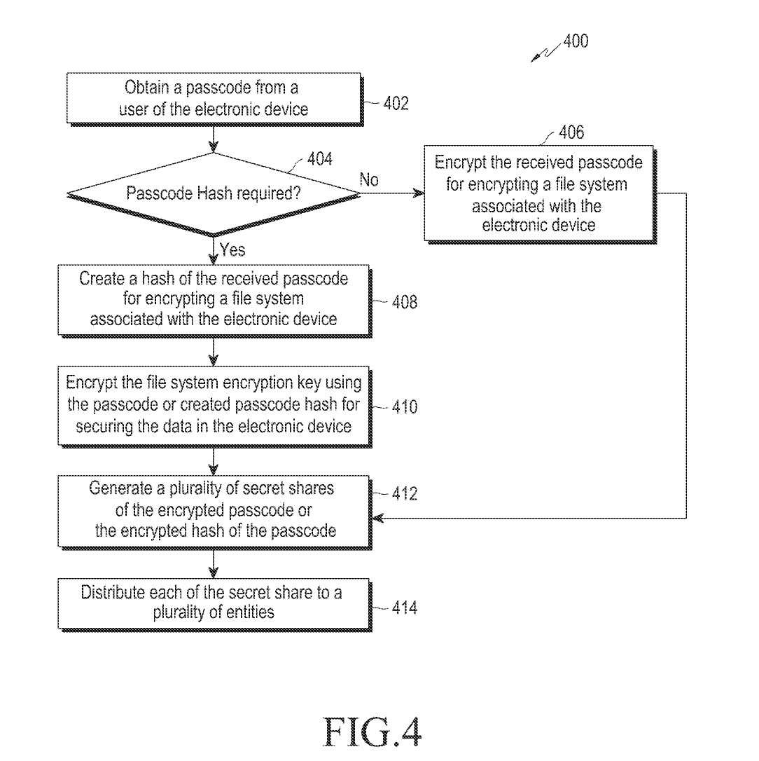

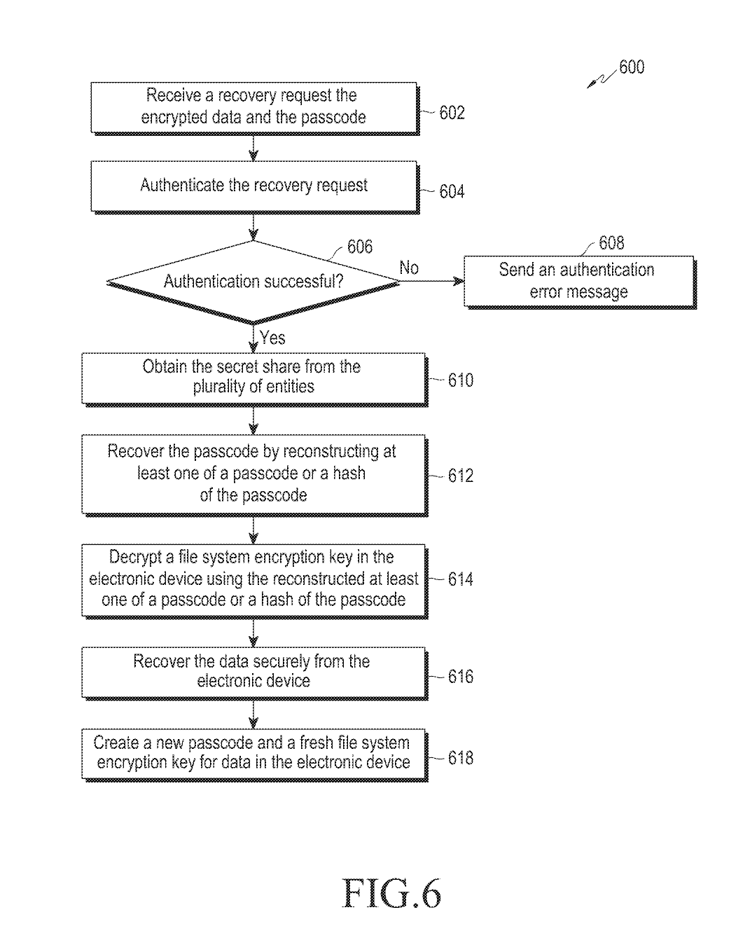

Data present in the container cannot be recovered in case the passcode is lost. To recover the passcode and the encrypted data present in the container, the embodiments described herein provides a recovery module 214 for recovering the passcode and the encrypted data present in the container of the electronic device 104. The recovery module 214 can be configured to recover the passcode and the encrypted data present in the electronic device 104. The details of the method of recovering the passcode and the encrypted data are provided in conjunction with FIG. 4 and FIG. 6. A policy management module (not shown) in the secure mode 204 of the electronic device 104 can be configured to receive policies for passcode recovery.

Examples of encrypted data may include sensitive data, including, but not limited to, enterprise data, data in applications requiring authentication like banking, ticketing, loyalty programs, cloud data, and proprietary data.

The FIG. 2 show a limited overview of the electronic device 104 but it is to be understood that other embodiments are not limited thereto. Further, the electronic device 104 may include the standard software and hardware components.

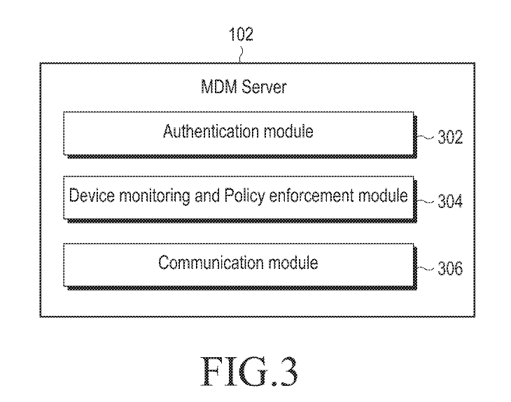

FIG. 3 illustrates modules of the MDM server 102 used for data security management, according to the embodiments as described herein. The MDM server 102 contains an authentication module 302, a device monitoring and policy enforcement module 304 and a communication module 306. The authentication module 302 can be configured to receive the passcode recovery request. If the user forgets the passcode, a passcode reset request may be received at the authentication module 306. The administrator of the MDM system 200 may perform a physical verification of received request.

In an embodiment, a web based interface for password recovery can be provided with administrator of the MDM system 200 to recover cloud storage in case of device loss or damage.

In an embodiment, if the electronic device 104 is reported lost or an employee has left the organization, the administrator of MDM server 102 managing the electronic device 104 can initiate a passcode recovery request and encrypted data recovery request.

The device monitoring and policy enforcement 304 in the MDM server can be configured to monitor the enterprise data present in the electronic device 104 and push various policies related to device monitoring, data security, and data recovery.

The communication module 306 can be configured to communicate with plurality of entities involved in the data security. For example, the communication module 306 can be configured to send authentication verification for a passcode reset request from an electronic device 104.

FIG. 4 is a flow diagram illustrating a method 400 for data security, according to the embodiments as described herein. The method 400 and other description described herein provide a basis for a control program, which can be implemented using a microcontroller, microprocessor or an equivalent thereof any other computer readable storage medium. In an embodiment, at step 402, the method 400 includes obtaining a passcode from the user of the electronic device 104. The passcode can be a combination of letters, numbers, words and symbols to authorize access to encrypted data in electronic device 104. For example, the user needs to enter the passcode for accessing enterprise applications and enterprise data present in the electronic device 104. In an embodiment, a secure keyboard can be implemented to enter the passcode safely in an enterprise based MDM system 200. At step 404, the method 400 includes checking if hash of the passcode is required. Based on the implementation, either the passcode or passcode hash can be used for the data security. At step 406, if no hash is required, a cryptographic module in the electronic device 104 can be configured to encrypt the received passcode for encrypting a file system associated with the electronic device 104. At step 408, if the pass code hash is required, the method 400 includes creating a hash of the received passcode for encrypting a file system associated with the electronic device 104. A cryptographic module can be configured to use existing algorithms to create a passcode hash.

At step 410, the method 400 includes encrypting the file system encryption key using the passcode or the created hash of the passcode for securing the encrypted data in the electronic device. To provide data security, files created in the secure environment, can be encrypted with a 256-bit key generated per file. This key is wrapped with a key generated from passcode hash and stored in a file system metadata. The file system metadata is encrypted using a file system key. The file system can be internal memory or SD card or cloud storage or any other form of storage.

At step 412, the method 400 includes generating a plurality of secret shares of the encrypted passcode or the encrypted hash of the passcode. The secret shares can be referred to as encrypted key shares. The cryptography module can be configured to create encrypted key shares of the passcode hash or the passcode.

At step 414, the method 400 includes distributing each of the secret shares to a plurality of entities. In an embodiment, the entity can include, but is not limited to, a server, a secure storage in the electronic device 104, a server, and the email-ID of the user. Further, the entity can also include a set of administrators of the server. For example, the secret shares associated with passcode of the electronic device 104 may be distributed between the server, the email ID of the user, and two administrators of the server responsible for monitoring and pushing policies into the electronic device 104 using the device monitoring and policy enforcement module 304.

The embodiments described herein use a Shamir's secret sharing algorithm or a Blakeley's scheme for enabling the data security in the electronic device 104. The Shamir's secret sharing algorithm allows a secret to be divided into parts, distributing each participant a unique part, where some of the parts or all of them are needed in order to reconstruct the secret shares. The encrypted passcode or passcode hash is divided into n encrypted key shares D1, D2 . . . Dn. D1, D2 . . . Dn can be distributed to n different entities. In an embodiment, the threshold defined determined the number of secret shares required to reconstruct the passcode.

The administrator of the MDM system 200 can be configured to define a threshold (k) for recovering the passcode based on the security level required for the encrypted data present in the electronic device 104.

Consider an example when three encrypted key shares are created from a passcode hash and the threshold level is two. A first encrypted key share is sent to a secure code present in the secure mode 104, a second encrypted key share is sent to the MDM server 104, and a third encrypted key share is sent to the enterprise email ID of the user. In case of a passcode loss, the recovery of data encrypted using the passcode in the electronic device 104 is feasible only when the two or more of the encrypted key share is available at the recovery module 214 of the electronic device 104. The process of recovering a passcode and recovering data from the secure mode of electronic device 104 is explained in detail in conjunction with FIG. 6.

Consider another example, when a passcode is received from a secure keyboard implemented in the secure environment provided by secure mode 204. The passcode hash may be converted into a hexadecimal string password secret. Then the password secret is converted in to 3 (Or more) secret shares (D1, D2, D3) with threshold (k=2 or more). The secret shares are then distributed to three entities; one share is sent to the MDM server 102, another share is kept within the secure storage of the electronic device 104 and other one is send to user email ID through a Secure Multipurpose Internet email Extensions (SMIME). All the three entities are physically separated. The threshold of k=2 means that the passcode can be recovered only when 2 or more of the secret shares are obtained from respective entities.

The various actions, acts, blocks, steps, and the like in the method 400 may be performed in the order presented, in a different order or simultaneously. Further, in some embodiments, some actions, acts, blocks, steps, and the like may be omitted, added, modified, skipped, and the like without departing from the scope of the invention.

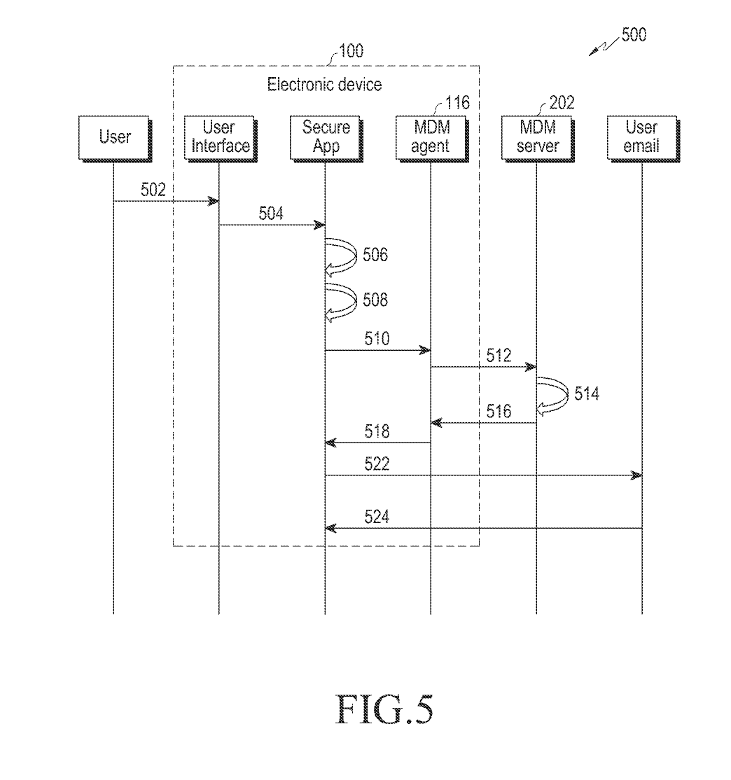

FIG. 5 is an example sequence diagram 500 showing various operations performed by different entities for data security in the electronic device 104, according to the embodiments as described herein. The sequence diagram 500 shows the various operations performed by various entities to generate and distribute a plurality of secret shares of the encrypted passcode or the encrypted hash of the passcode to a plurality of entities. At 502, the user enters a passcode at the user interface of the electronic device 104. At 504, the electronic device 104 can be configured to request secret share generation of the entered user passcode from a secure application in the electronic device 104. At 506, the secure application generates secret shares after encrypting the passcode or the passcode hash. This secure application is present in the secure mode 204 of the electronic device. At 508, a first secret share of the generated secret shares is stored within the secure storage of the secure application. At 510, a second secret share of the generated secret shares is sent to the MDM server 106 present in the secure mode 204 of the electronic device 104. At 512, the MDM server 106 can be configured to communicate the secret share to the MDM server 102. At 514, the secret share received at the MDM server 102 is stored securely at the MDM server 102. At 516 and 518, an acknowledgement of the received secret share is sent from the MDM server 102 to the secure application through the MDM server 106. At 522, a third secret share of the generated secret shares is sent to a user email through a Secure Multipurpose Internet email Extensions (SMIME). At 524, an acknowledgement from the user email ID confirming the receipt of the secret share is sent to the secure application.

FIG. 6 is a flow diagram illustrating a method 600 of recovering a passcode for recovery of encrypted data, according to the embodiments as described herein. The method 600 and other description described herein provide a basis for a control program, which can be implemented using a microcontroller, microprocessor or an equivalent thereof any other computer readable storage medium.

In an embodiment, at step 602, the method 600 includes receiving a recovery request for recovery of at least one of the encrypted data and the passcode. The recovery request is received at the MDM server 102. When a user forgets his passcode, the user can send a passcode reset request to the administrator of the MDM server 102. The administrator can generate a recover request for recovering the encrypted data from an electronic device 104.

At step 604, the method includes authenticating the recovery request. In an embodiment, the administrator of the MDM server 102 can authenticate the recovery request after a physical verification of authenticity of the recovery request. The administrator can verify the employee credential as well as status of the electronic device 104 if required.

At step 606, the method 600 includes determining if the authentication is successful. At step 608, the method 600 includes sending an authentication error message, if the authentication is unsuccessful.

At step 610, if the authentication is successful, the method 600 includes obtaining each secret share from the plurality of entities. The administrator can provide a policy for recovery of the passcode and the encrypted data based on the authentication and threshold set for passcode recovery. If the recovery request is for lost passcode, the policy pushed into the electronic device 104 is for passcode recovery.

At step 612, the method 600 includes recovering the passcode by reconstructing at least one of a passcode or a hash of the passcode. The recovery module 214 can be configured to reconstruct the passcode or a hash of the passcode by reconstructing the passcode/passcode hash from the distributed secret shares from the plurality of entities. The Shamir's algorithm or the Blakeley's scheme can be used for secret share creation and reconstruction.

The recovery module 214 reconstructs the passcode (or the passcode hash) in a secure code in the secure environment provided in the secure mode 204. The reconstructed passcode or the passcode hash is available for a short period of time in volatile memory to reduce the risk of attack at the time of reconstruction of the passcode/passcode hash.

The embodiments described in the method and system provides high data security, as the secret shares are distributed to different entities, which are separated physically. In an embodiment, for “n” number of secret shares of the passcode located at different physical entities, the reconstruction of passcode may not be feasible without getting access to a “k” number of secret shares, where k is the threshold set for the electronic device 104. Further, any one entity does not have encrypted share of the passcode. A comprise of security at any one of the entity, may not reveal the passcode.

The system and method described in the embodiment provide flexibility to reconstruct the passcode based on the threshold defined for the electronic device.

Example for Passcode Recovery Based on Threshold

Consider an example, when a passcode has been encrypted and three different shares of the encrypted passcode hash have been generated with a threshold of 2. The secret shares are then distributed to three entities—One share is sent to the MDM server 102, another share is kept within the secure storage of the electronic device 104 and other one is send to user email through the SMIME. The threshold of k=2 means that the passcode can be recovered only when 2 or more of the secret shares are obtained from respective. On receiving a password recovery request, the administrator at the MDM server 102 can verify the authenticity of password recovery request and send his share of secret with password change policy to the MDM server 106 in the electronic device 104. The recovery module 214 in the electronic device 104 can verify the authenticity of administrator request and reconstruct the passcode or the passcode hash again using a share present in the secure storage and the MDM server's 202 secret share.

Passcode Recovery in Case of Server Failure

In the above example, the passcode can be recovered from the secret share sent to the user and the secret share present in the secure storage if the security of MDM server 102 is comprised.

Passcode Recovery in Case of Hardware Failure

In the above example, the passcode can be recovered from the secret share sent to the user and the secret share received from the MDM server 102 if there is a hardware failure in the electronic device 104 and the secret share present in the secure storage of the electronic device 104 is lost.

At step 614, the method 600 includes decrypting a file system encryption key in the electronic device 104 using the reconstructed at least one of a passcode or a hash of the passcode. When the data in the electronic device 104 is encrypted using the passcode/passcode hash, the data can be recovered of data once the passcode/passcode is reconstructed. At step 616, the method 600 includes recovering the data securely from the electronic device 104. At step 618, the method 600 includes creating a new passcode and a fresh file system encryption key for the data in the electronic device 104.

The various actions, acts, blocks, steps, and the like in the method 600 may be performed in the order presented, in a different order or simultaneously. Further, in some embodiments, some actions, acts, blocks, steps, and the like may be omitted, added, modified, skipped, and the like without departing from the scope of the invention.

Although the methods 400 and 600 are described for an electronic device 104, it must be understood that embodiments of the methods are not restricted to electronic device 104.

Consider an example, when encrypted data stored in an external memory of cloud storage can be secure if the passcode is not available with a cloud storage provider.

Consider another example, when an employee can store files in enterprise controlled cloud storage. If files stored on the enterprise controlled cloud storage are encrypted in the user electronic device 104, these files can be recovered using the method described in method 400 and method 600.

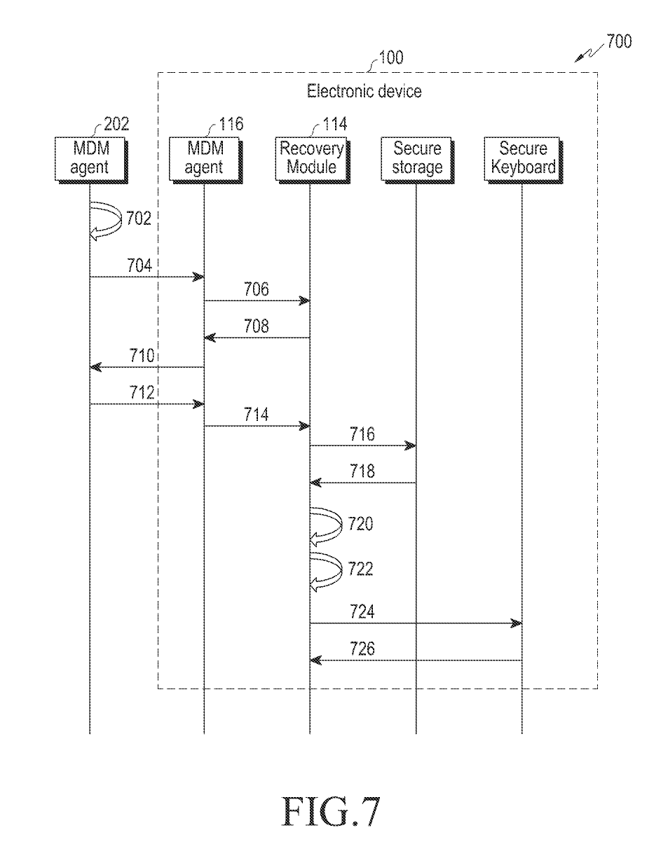

FIG. 7 is an example sequence diagram 700 showing various operations performed by different entities recovering a passcode for data recovery, according to the embodiments as described herein. In an embodiment, at 702, the administrator of the MDM server 102 can be responsible for authenticating the request for passcode recovery and encrypted data recovery is received at the MDM server 102. At 704 and 706, after authentication, the administrator of the MDM server 102 can push an enable recovery policy into the recovery module 214 in the electronic device 104. At 708 and 710, the recovery module 214 can be configured to request the secret share present in the MDM server 102 through the MDM server 106. At 712 and 714, the recovery module 214 can be configured to receive the secret share from the MDM server 102 through the MDM server 106. At 716, the recovery module 214 can be configured to request the secret share present in the secure storage of the electronic device 104. At 718, the secret share from the secure storage is received at the recovery module 114. At 720, the recovery module 214 can be configured to reconstruct the passcode or the passcode hash using secret sharing and reconstruction algorithms. At 722, once the passcode is recovered, the recovery module 214 can be configured to decrypt the file system key associated with the encrypted data and destroy the recovered passcode. At 724, the recovery module 214 can be configured to request the user to enter a new passcode using the secure keyboard. At 726, the recovery module 214 receives the new passcode.

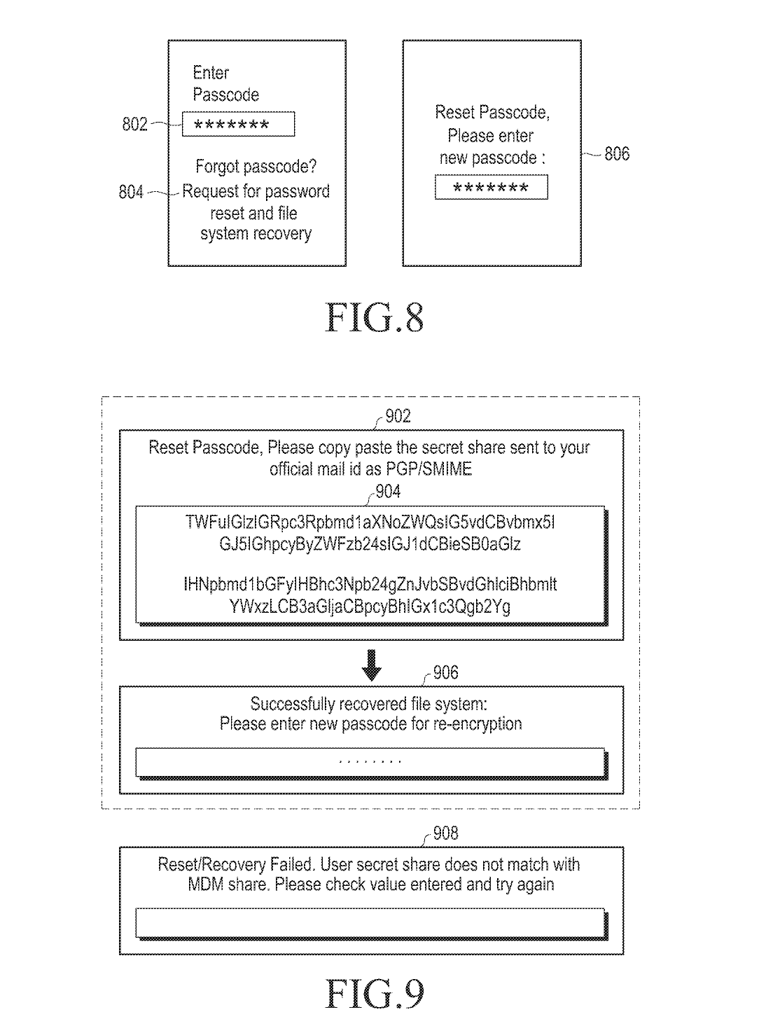

FIG. 8 is an example illustration depicting the steps involved for recovering the passcode using a user interface, according to the embodiments as described herein. At 802, the user interface requesting entry of passcode for accessing the enterprise data present in the electronic device 104 is shown. The user interface provides a recovery request as shown in 804. When user clicks on a password reset option, the reset request can be sent to the administrator of the MDM server 102. The administrator of the MDM server 102 can physically verify the authenticity of request and set policy to reset the password. Once the authentication is successful, and the user needs to create a new passcode and the UI provides instructions to enter the new passcode (shown as 806) to rest the passcode.

FIG. 9 is an example illustration depicting the steps involved for recovering the passcode using a secret share sent to user and a secret share sent to the MDM server 102 when the electronic device 104 is lost, according to the embodiments as described herein. In case of electronic device 104 loss and recovery of encrypted data from cloud storage, a dynamically generated recovery Uniform Resource Locator (URL) will be given to the user after enterprise administrator verifies the authenticity of recovery request. On clicking the URL the user interface shown 902 can be rendered on the electronic device. The user is requested to copy paste the secret share sent to user's email ID. A copy pasted secret share is shown in 904. On receiving the correct secret share, the encrypted data and file system in the electronic device can be recovered. A new passcode is set immediately after the passcode recovery. The user is requested to enter a new passcode (shown in 906). If the user's secret share and the secret share present in the MDM server 102 don't match to form the passcode, then a recovery-failed message is displayed. The user may be requested to check the entered passcode.

The recovery of the passcode and threshold can be configured at the MDM server 102. For example, to recover encrypted data a combination of secret shares from the user's email, a secret share stored in the secure mode 204, and the administrator can be defined in the policy set for recovery. The recovery module 114 receives a set of policies for passcode recovery and encrypted data recovery from the MDM server 102.

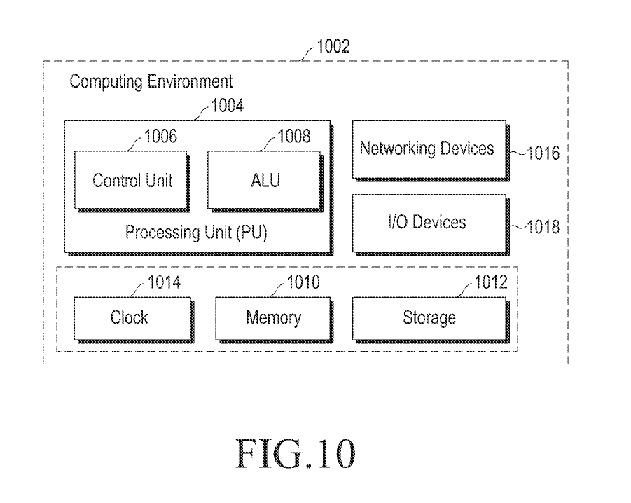

FIG. 10 depicts a computing environment implementing the method for data security, in accordance with various embodiments as described herein. As depicted, the computing environment 1002 comprises at least one processing unit 1004 that is equipped with a control unit 1006 and an Arithmetic Logic Unit (ALU) 1008, a memory 1010 a storage unit 1012, a clock chip 1014, plurality of networking devices 1016, and a plurality Input output (I/O) devices 1018. The processing unit 1004 is responsible for processing the instructions of the algorithm. The processing unit 1004 receives commands from the control unit 1006 in order to perform its processing. Further, any logical and arithmetic operations involved in the execution of the instructions are computed with the help of the ALU 1008.

The overall computing environment 1002 can be composed of multiple homogeneous or heterogeneous cores, multiple CPUs of different kinds, special media and other accelerators. The processing unit 1004 is responsible for processing the instructions of the algorithm. The processing unit 1004 receives commands from the control unit 1006 in order to perform its processing. Further, any logical and arithmetic operations involved in the execution of the instructions are computed with the help of the ALU 1008. Further, the plurality of process units may be located on a single chip or over multiple chips.

The algorithm comprising of instructions and codes required for the implementation are stored in either the memory unit 1010 or the storage 1012 or both. At the time of execution, the instructions may be fetched from the corresponding memory 1010 or storage 1012, and executed by the processing unit 1004. The processing unit 1004 synchronizes the operations and executes the instructions based on the timing signals generated by the clock chip 1014. The embodiments disclosed herein can be implemented through at least one software program running on at least one hardware device and performing network management functions to control the elements.

The embodiments disclosed herein can be implemented through at least one software program running on at least one hardware device and performing network management functions to control the elements. The elements shown in FIGS. 1, 2, 3, 5, 7, and 9 include blocks which can be at least one of a hardware device, or a combination of hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method of providing data security, the method comprising:
generating a plurality of secret shares for an encrypted passcode; and
distributing each the secret share to a plurality of entities, wherein the plurality of entities are separated physically.

2. The method of claim 1, wherein generating a plurality of secret shares for an encrypted passcode comprises:
obtaining the passcode;
encrypting one of: the passcode and passcode hash; and
generating the plurality of secret shares for one of: the encrypted passcode and encrypted passcode hash.

3. The method of claim 1, wherein the plurality of shares is generated based on a threshold.

4. The method of claim 1, wherein the method further comprises:
receiving a recovery request to recover at least one of an encrypted data and the passcode;
obtaining each the secret share from the plurality of entities;
recovering the passcode by reconstructing the passcode; and
recovering an encrypted data by decrypting the encrypted data using the reconstructed passcode.

5. The method of claim 4, wherein the encrypted data is recovered based on at least one policy.

6. A system for data security, the system comprising an electronic device managed by a Mobile Device Management (MDM) server, wherein the system is configured to:
generate a plurality of secret shares for an encrypted passcode; and
distribute each the secret share to a plurality of entities, wherein the plurality of entities is separated physically.

7. The system of claim 6, wherein a recovery module in the electronic device is configured to:
obtain the passcode;
encrypt one of: the passcode and passcode hash; and
generate the plurality of secret shares for one of: the encrypted passcode and encrypted passcode hash.

8. The system of claim 6, wherein the plurality of shares is generated based on a threshold, wherein the MDM server is configured to determine the threshold.

9. The system of claim 6, wherein the recovery module in the electronic device is further configured to:
receive a recovery request to recover at least one of an encrypted data and the passcode;
obtain each the secret share from the plurality of entities;
recover the passcode by reconstructing the passcode; and
recover an encrypted data by decrypting the encrypted data using the reconstructed passcode.

10. The system of claim 9, wherein the encrypted data is recovered based on at least one policy.

11. A computer program product comprising computer executable program code recorded on a computer readable a non-transitory storage medium, the computer executable program code when executed, causing the actions including:
generating a plurality of secret shares for an encrypted passcode; and
distributing each the secret share to a plurality of entities, wherein the plurality of entities are separated physically.

12. The computer program product of claim 11, wherein the computer executable program code when executed, further causing the actions including:
obtaining the passcode;
encrypting one of: the passcode and passcode hash; and
generating the plurality of secret shares for one of: the encrypted passcode and encrypted passcode hash

13. The computer program product of claim 11, wherein the plurality of shares is generated based on a threshold.

14. The computer program product of claim 11, wherein the computer executable program code when executed, further causing the actions including:
receiving a recovery request to recover at least one of an encrypted data and the passcode;
obtaining each the secret share from the plurality of entities;
recovering the passcode by reconstructing the passcode; and
recovering an encrypted data by decrypting the encrypted data using the reconstructed passcode.

15. The computer program product of claim 14, wherein the encrypted data is recovered based on at least one policy.
